(19) United States
(12) Patent Application Publication
(10) Pub. No.: US 2003/0053078 A1
(43) Pub. Date: Mar. 20, 2003

(54) Microelectromechanical tunable fabry-perot wavelength monitor with thermal actuators

(76) Inventors: Mark Missey, Santa Clara, CA (US); Bardia Pezeshki, Redwood City, CA (US)

Correspondence Address: KUDIRKA & JOBSE, LLP, ONE STATE STREET, SUITE 1510, BOSTON, MA, 02109, US

(21) Appl. No.: 09/954,974

(22) Filed: Sep. 17, 2001

(51) Int. Cl. G01B 9/02

(52) U.S. Cl. 356/519

(57) ABSTRACT

A microelectromechanical wavelength monitor includes a first wafer that includes a first movable layer. A first chevron is a thermal actuator that is connected to the first movable layer by a first tether. A second chevron is a thermal actuator that is connected to the first movable layer by a second tether. A second wafer is bonded to the first wafer and includes a trench defining a second stationary layer that is flat or curved. The first and second chevrons adjust a distance between the first movable layer and the second stationary layer to vary a resonated wavelength between the first and second stationary layers. The first movable layer includes an antireflective coating formed on an outer surface thereof. The first and second movable layers include a highly reflective coating formed on an inner surface thereof.

### FIELD OF THE INVENTION

The present invention relates to wavelength monitors, and more particularly to microelectromechanical tunable Fabry-Perot wavelength monitors with thermal actuators.

### BACKGROUND OF THE INVENTION

Microelectromechanical (MEMS) wavelength monitors or interferometers are important components in wavelength division multiplexing (WDM) telecommunications systems. For example, optical lasers employ tunable wavelength monitors that generate wavelength error feedback signals. MEMS-based wavelength monitors are currently produced by companies such as Coretek and Axsun. When compared with bulk optical interferometers, such as the bulk optical interferometer that is produced by SDL-Queensgate, the MEMS-based wavelength monitors are easier to fabricate, require less alignment, and are smaller and lower-cost.

Conventional MEMS-based wavelength monitors, however, have some significant performance issues that need to be addressed. For example, the Coretek MEMS tunable filter is temperature sensitive and cannot handle significant power levels. The Axsun MEMS tunable filter is capable of handling high power levels but has problems associated with fabrication and repeatability.

Conventional MEMS-based wavelength monitors employ either parallel flat mirrors or a curved mirror that forms a confocal or semi-confocal cavity. The parallel flat mirrors are extremely sensitive to parallelism and have beam walk-off problems. Therefore, some form of dynamic adjustment for parallelism must be incorporated into designs incorporating parallel flat mirrors. One MEMS-based interferometer, for example, includes four electrostatic actuators and four sensing capacitors. The sensing capacitors provide feedback that is used to continually adjust for parallelism. The Coretek and Axsun wavelength monitors use a single curved mirror to eliminate diffraction losses and to lower the sensitivity to misalignment of the surfaces. Generally, the confocal cavity approach produces a higher finesse than can be obtained with wavelength monitors using parallel flat mirrors.

Generally, conventional MEMS wavelength monitors are fabricated from two or more dissimilar materials that have temperature stability problems. The Coretek device uses a suspended membrane that is fabricated out of silicon nitride and aluminum. The temperature of the chip varies due to environmental effects and/or absorbed power. The membrane has a different thermal expansion coefficient as compared with the underlying semiconductor substrate. As the temperature of the chip varies, the stress in the tethers changes and varies the transmission properties of the wavelength monitor.

The surface micromachined wavelength monitors must maintain precise control over the stress and uniformity of the film for proper operation. Wavelength monitors fabricated out of bulk silicon or semiconductor wafers have fewer problems with stress and uniformity. The bulk silicon wavelength monitors have a higher thermal mass and improved dissipation that protects against temperature variation due to the absorbed power. Additionally, there is no variation in the built-in stress with temperature because the temperature expansion coefficient is the same for the two sides of the wavelength monitor.

All of the conventional MEMS wavelength monitors employ electrostatic actuators for tuning the cavity. The electrostatic force is generally extremely weak. As a result, the reactive elements, such as the springs and tethers, must have very small spring constants to provide sufficient movement. During fabrication, the fragile reactive elements are easily damaged, which increases the complexity of the fabrication process. This is particularly true when passing a high-rate flow of water across the wafer during the dicing process. Wavelength monitors with electrostatic actuators are also more sensitive to shock, vibration and environmental effects. For example, the passband of these devices is often unstable in real-world environments. To compensate for variation and drift, some devices require a light source and an etalon for periodic calibration. These devices increase the cost and complexity of the wavelength monitor. While electrostatic actuation consumes relatively low-power, it requires a relatively high operating voltage.

### SUMMARY OF THE INVENTION

A microelectromechanical wavelength monitor according to the invention includes a first wafer that includes a first movable layer. A first chevron is connected to the first movable layer. A second chevron is connected to the first movable layer. A second wafer is bonded to the first wafer and includes a trench defining a second stationary layer. The first and second chevrons are thermal actuators that adjust a first distance between the first movable layer and the second stationary layer.

In other features of the invention, the first and second surfaces are connected to the first and second chevrons using first and second tethers. The first movable layer includes an antireflective coating formed on an outer surface thereof. The first movable layer includes a highly reflective coating formed on an inner surface thereof. The first movable layer is patterned in a first semiconductor layer of the first wafer.

In other features, the first chevron includes a first out-of-plane actuator and the second chevron includes a second out-of-plane actuator. The second stationary layer is flat or curved. The second stationary layer has a highly reflective coating formed thereon.

In yet other features, a third chevron is connected to the first movable layer by a third tether. A fourth chevron is connected to the first movable layer by a fourth tether. The first movable layer is generally rectangular and the first, second, third and fourth tethers are connected to mid-portions of first, second, third and fourth edges of the first movable layer. Alternately, the first movable layer is generally circular and the first, second and third tethers are approximately equally spaced around the first movable layer.

In still other features, the first movable layer, the first and second tethers and the first and second chevrons are patterned in a single semiconductor layer. The first and second chevrons are partially released from a substrate and the first movable layer is fully released from the substrate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a Fabry-Perot etalon according to the prior art;

FIG. 2 illustrates waveforms generated by the Fabry-Perot etalon of FIG. 1;

FIG. 3 illustrates the Fabry-Perot etalon of FIG. 1 in an exemplary tunable laser embodiment;

FIG. 4 illustrates a MEMS tunable Fabry-Perot wavelength monitor according to the present invention that includes thermal actuators;

FIG. 5 is a perspective view illustrating a movable mirror structure of the wavelength monitor of FIG. 4 in a planar position;

FIG. 6 is a perspective view illustrates the movable mirror structure of the wavelength monitor of FIG. 4 in an extended position;

FIG. 7 illustrates a trench that is etched in a silicon wafer;

FIG. 8 illustrates an exemplary movable structure including a silicon layer formed on a silicon on insulator (SIO) wafer;

FIG. 9 illustrates a plan view of the movable mirror of FIG. 6 patterned in the silicon (Si) layer of FIG. 8.

### DETAILED DESCRIPTION OF THE PREFERRED EMBODIMENTS

The following description of the preferred embodiment(s) is merely exemplary in nature and is in no way intended to limit the invention, its application, or uses.

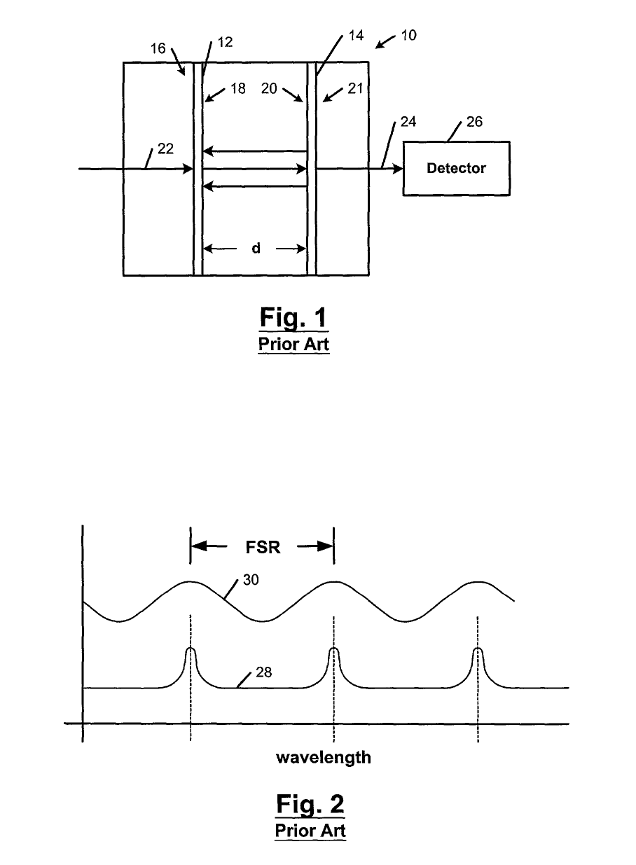

Referring now to FIGS. 1 and 2, a Fabry-Perot etalon 10 according to the prior art is illustrated. The Fabry-Perot etalon 10 includes two spaced, partially-reflecting mirrors 12 and 14. The partially-reflecting mirror 14 typically includes an antireflective coating 16 on one surface and a highly reflective coating 18 on an opposite surface. The partially-reflecting mirror 12 typically includes a highly reflective (HR) coating 20 on one surface and an antireflective (AR) coating on an opposite surface 21. An input light beam of light 22 is directed onto the partially-reflecting mirror 12.

Approximately 99% of incoming light is reflected by the mirror 12 and approximately 1% passes through the mirror 12. Resonation occurs between the partially reflecting mirrors 12 and 14. The particular wavelength of the resonation depends upon a distance d between the partially reflecting mirrors 12 and 14 and the free spectral range (FSR) is proportional 1/d. An output beam of light 24 that is resonated by the etalon 10 passes through the partially reflecting mirror 14 and is incident upon a detector 26. For a high Q etalon 10, an output signal 28 has a plurality of peaks that are separated by the FSR. For a low Q etalon 10, the output signal is sinusoidally-shaped and also has a plurality of peaks that are separated by the FSR.

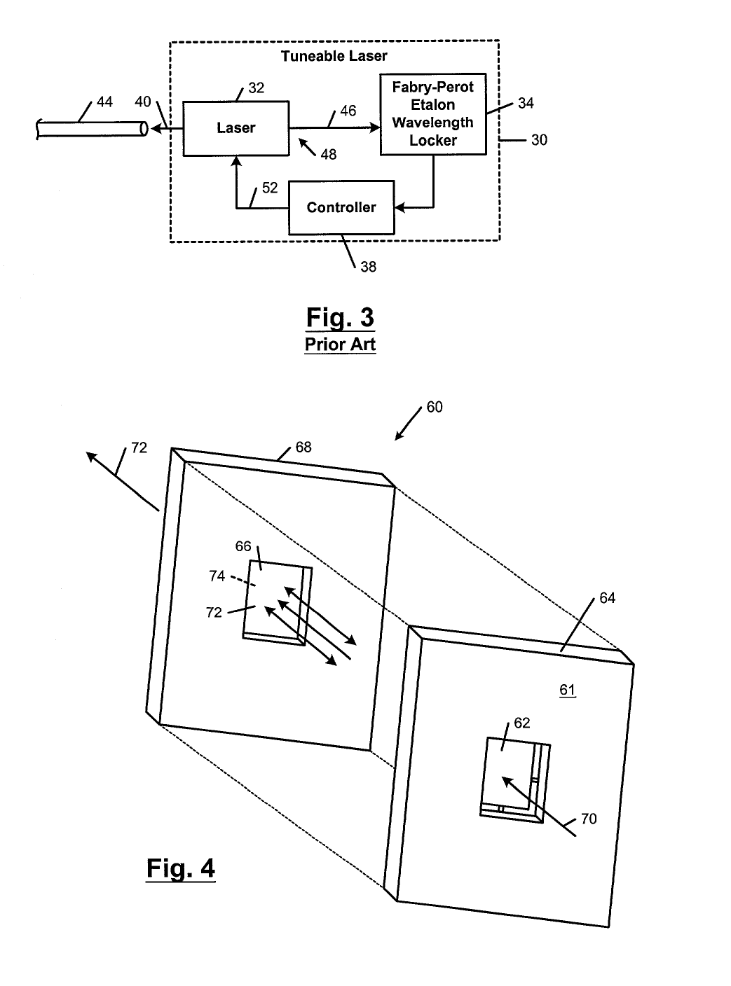

Referring now to FIG. 3, a tunable laser 30 includes a laser 32 and a wavelength locker 34. A controller 38 may be packaged with the tunable laser 30 and/or the wavelength locker 34 or packaged separately. The laser 32 generates a primary beam of light 40 at an output 42 onto fiber 44 and a secondary beam of light 46 having relatively low power at a tap 48. The primary and secondary beams of light 40 and 46 have a wavelength (λ). Using the secondary beam of light 46, the wavelength locker 34 and detector(s) (not shown) generate sensing signal(s) 50 that are output to the controller 38. The controller 38 determines an error signal based on a difference between the wavelength (λ) of the laser 32 and a desired wavelength (λ_{d}) using the sensing signals 50. The controller 38 generates a control signal 52 that adjusts the wavelength (λ) to the desired wavelength (λ_{d}). Conventional wavelength lockers 14 are typically fabricated using Fabry-Perot etalons, such as electrostatically actuated MEMS devices. Skilled artisans can appreciate that the wavelength monitor has a wide variety of other applications in addition to tunable lasers.

Referring now to FIG. 4, a MEMS tunable Fabry-Perot wavelength monitor with thermal actuators according to the present invention is illustrated and is generally designated 60. The wavelength monitor 60 includes a mirror structure 62 that is suspended and movable relative to a first wafer 64. The wavelength monitor 60 further includes a trench 66 that is formed in a second wafer 68.

As with other Fabry-Perot devices, an input beam of light 70 is directed at the suspended mirror structure 62. Some of the light passes through the suspended mirror structure 62. The wavelength of light that resonates between the trench 66 and the suspended mirror structure 62 depends upon a distance between the trench 66 and the suspended mirror structure 62. Some of the light that passes through the trench 66 forms an output beam of light 72 that is received by a detector. Skilled artisans will appreciate that the distance between the wafers 64 and 68 is exaggerated in the partial assembly view of FIG. 4 to illustrate the structure of the suspended mirror structure 62 and the trench 66.

Referring now to FIG. 8, the trench 66 is preferably etched into the substrate 68 using an etch-stop layer for a flat partially reflecting mirror or a reflowed photoresist process for a curved or spherical partially reflecting mirror. As previously discussed, the curved or spherical partially reflecting mirror produces a stable cavity that is capable of producing a higher finesse and is less sensitive to alignment errors. The depth of the trench 66 determines the cavity length, free spectral range (FSR), and “off” state transmission wavelength of the wavelength monitor 60. The trench 66 is preferably coated with a highly reflective (HR) coating 72 on an inner surface thereof and an anti-reflective (AR) coating 74 on an outer surface thereof.

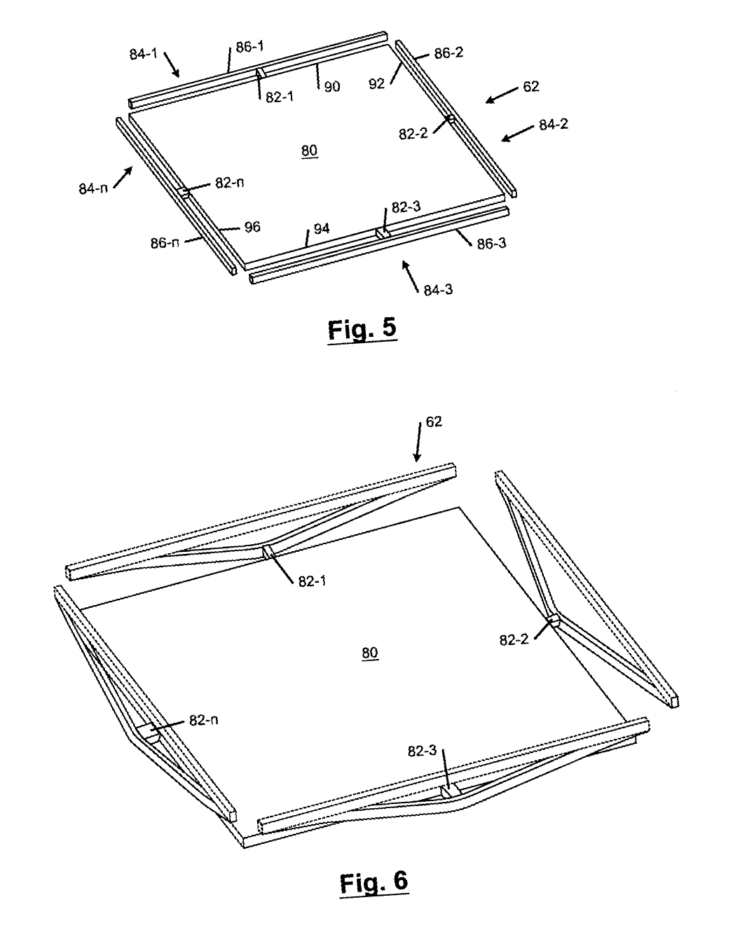

Referring now to FIG. 5, the suspended mirror structure 62 is shown in further detail. The suspended mirror structure 62 includes a partially reflecting mirror 80 that is connected by tethers 82-1, 82-2, . . . , 82-n to a plurality of chevrons 84-1, 84-2, . . . , 84-n. Preferably, the chevrons 84 are thermal actuators 86-1, 86-2, . . . , 86-n that move in an out-of-plane direction. In other words, the chevrons 84 move in the z axis when the mirror lies in the x-y axis. In a preferred embodiment, the mirror 80 has a square shape with four tethers located at mid-points of side surfaces 90, 92, 94 and 96 of the mirror 80.

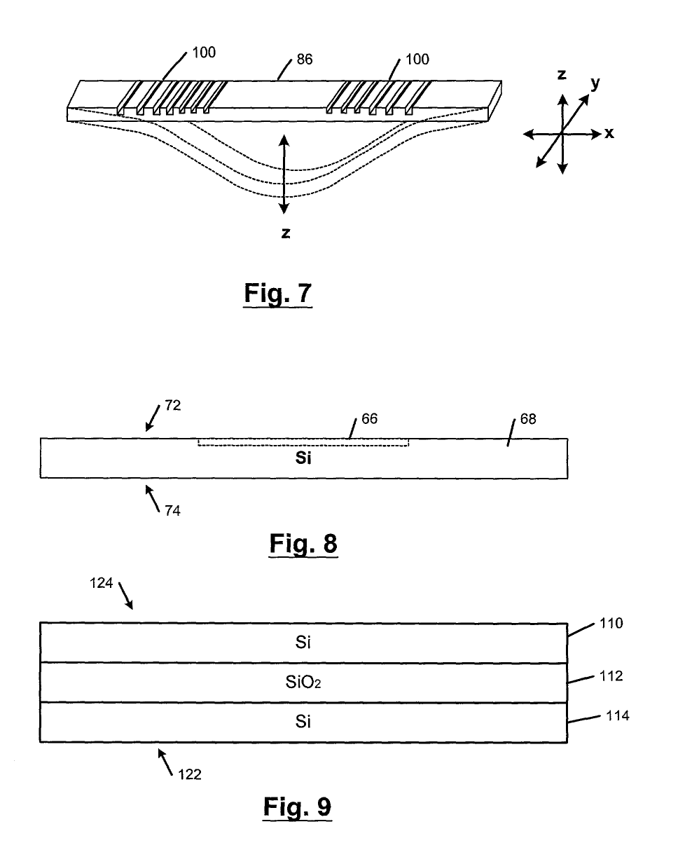

Referring now to FIGS. 6 and 7, the suspended mirror structure 62 is shown in an extended position. When current is passed through the thermal actuators 86, the thermal actuators 86 heat and expand. A plurality of notches 100 may be formed in the actuators 86 on a side opposite to the direction of intended movement to facilitate bending. To make the actuator 86 preferentially buckle in the out-of-plane direction, the beams forming the out-of-plane actuator 86 are made much thicker in the in-plane direction than in the out-of-plane direction. Best performance is achieved when the actuator thickness out-of-plane is tapered linearly from the anchored ends to the center of the beam. This can be performed using grayscale photoresist technology, by etching trenches of equal or varying depth into the beam or by other similar techniques.

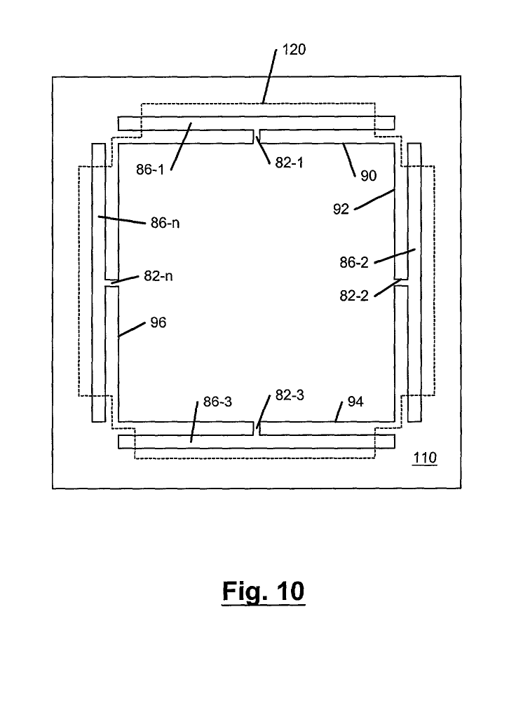

Referring now to FIGS. 9 and 10, an exemplary method for fabricating the thermally actuated MEMS mirror structure 62 is shown. A silicon layer 110 having a desired thickness is bonded, grown or sputtered on a silicon on insulator (SOI) wafer including silicon dioxide (SiO₂) and silicon (Si) layers 112 and 114. A bottom side or topside etch is performed to release selected portions of the thermally actuated MEMS mirror structure 62. For example, the portions lying within the dotted lines 120 in FIG. 9 are released while the portions outside the dotted line 120 remain attached. After patterning, an anti-reflective (AR) coating 122 is formed on an outer surface of the mirror structure 62 and a highly reflective (HR) coating 124 is formed on an inner surface of the mirror structure 62.

While the mirror 80 has a rectangular shape in FIG. 5, other shapes may be employed. For example, a circular mirror structure or other suitable shapes may be employed. The circular mirror structure requires fewer tethers, for example, three tethers may be employed with spacing at 120° apart.

The thermally actuated mirror structure 62 can be fabricated using surface or bulk micromachining processes. The presently preferred method for fabricating the thermally actuated mirror structures is the bulk micromachining process due to its inherent repeatability and fewer problems with surface micromachining. The thermally actuated mirror structure 62 can be easily fabricated using bulk micromachining with silicon wafers or bulk micromachining with SOI wafers.

In either case, the structure is formed by etching the front surface with a single masking step. A metalization step defines device contacts (not shown) and the highly reflective (HR) layer on the surface of the mirror 80. Portions of the thermally actuated mirror structure 62 are then released using backside etching. When SOI micromachining is performed, a hydrofluoric (HF) dip is used to remove the SiO₂ layer 112. A second etching step on the front surface or a stressed film can be used to break the symmetry and cause buckling in a preferred direction.

The inner surfaces of the substrates 64 and 68 are fused together. Preferably, the substrates 64 and 68 are fused together using anodic bonding. As a result, a high finesse Fabry-Perot cavity is formed between the tethered mirror and the trench. As power is adjusted to the chevrons 84, the suspended mirror is translated along the z axis to increase or decrease the cavity and to change the transmitted wavelength. Cavity alignment is maintained by supplying unequal current and/or voltage to the chevrons 84 to cause the mirror 80 to be tipped in a desired direction.

The trench 66 is etched in the silicon wafer 68. The finesse of the flat cavity that is formed between the etched trench 66 and the mirror 80 is dependent on the parallelism of the two surfaces. In general, the parallelism between the two surfaces (after anodic bonding) should be less than approximately 10⁻² degrees. The mirror design set forth above allows for post-assembly parallelism control. This is possible because the mirror structure 62 provides both planar motion and tilt motion in any direction. The wavelength monitor 60 can be calibrated electronically for errors that occur during fabrication. In addition, the finesse of the cavity can be deliberately reduced by tilting the mirror 80 for a low resolution scan.

Etching a curved or spherical trench into the Si wafer is relatively straightforward using the commercially-available photoresist reflow process. The advantage of the spherical trench 66 is that it forms a stable cavity. The maximum achievable finesse of the spherical trench is larger than the finesse of the flat cavity trench that is limited by the diffraction of the incident beam. In addition, misalignment of the mirror 80 in the stable cavity configuration leads to increased insertion loss but does not result in the degradation of the cavity finesse.

While the mirror 80 may heat up due to the direct connection to the tethers 82, the relatively low temperatures that are required for motion are likely to cause negligible stress on the silicon and the coatings. Alternately, the tethers 82 may be altered to limit thermal diffusion into the mirror 80 while providing sufficient mechanical linkage.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A microelectromechanical wavelength monitor, comprising:
a first wafer that includes a first movable layer, a first chevron connected to said first movable layer, and a second chevron connected to said first movable layer; and
a second wafer that is bonded to said first wafer and includes a second stationary layer;
wherein said first and second chevrons are thermal actuators that adjust a distance between said first movable layer and said second stationary layer.

2. The wavelength monitor of claim 1 wherein said first and second chevrons are attached to said first moveable layer by first and second tethers

3. The wavelength monitor of claim 1 wherein said first movable layer includes an antireflective coating formed on an outer surface thereof.

4. The wavelength monitor of claim 2 wherein said first movable layer includes a highly reflective coating formed on an inner surface thereof.

5. The wavelength monitor of claim 2 wherein said first movable layer, said first and second chevrons and said first and second tethers are patterned in a first semiconductor layer of said first wafer.

6. The wavelength monitor of claim 1 wherein said first chevron includes a first out-of-plane actuator and said second chevron includes a second out-of-plane actuator.

7. The wavelength monitor of claim 1 wherein said second stationary layer is flat.

8. The wavelength monitor of claim 1 wherein said second stationary layer is curved.

9. The wavelength monitor of claim 1 wherein said second stationary layer has a highly reflective coating formed thereon.

10. The wavelength monitor of claim 2 further comprising a third chevron connected to said first movable layer by a third tether.

11. The wavelength monitor of claim 10 further comprising a fourth chevron connected to said first movable layer by a fourth tether.

12. The wavelength monitor of claim 11 wherein said first movable layer is generally rectangular and said first, second, third and fourth tethers are connected to mid-portions of first, second, third and fourth edges of said first movable layer.

13. The wavelength monitor of claim 10 wherein said first movable layer is generally circular and said first, second and third tethers are approximately equally spaced around said first movable layer.

14. The wavelength monitor of claim 2 wherein said first movable layer, said first and second tethers and said first and second chevrons are patterned in a single semiconductor layer.

15. The wavelength monitor of claim 14 wherein said first and second chevrons are partially released from a substrate and said first movable layer is fully released from said substrate.

16. A microelectromechanical wavelength monitor, comprising:
a first semiconductor wafer including a first semiconductor layer;
a second semiconductor wafer including a trench defining a second stationary layer;
a first movable layer formed in said first semiconductor layer;
a first thermal actuator formed in said first semiconductor layer adjacent to said first movable layer and connected to said first movable layer by a first tether;
a second thermal actuator formed in said first semiconductor layer adjacent to said first movable layer and connected to said first movable layer by a second tether; and
a third thermal actuator formed in said first semiconductor layer adjacent to said first movable layer and connected to said first movable layer by a third tether;
wherein said first, second, and third thermal actuators adjust a distance between said first movable layer and said second stationary layer.

17. The wavelength monitor of claim 16 wherein said first movable layer and said second stationary layer include highly reflective coatings.

18. The wavelength monitor of claim 16 wherein said first movable layer is circular and said first, second and third thermal actuators are spaced approximately 120° apart.

19. The wavelength monitor of claim 16 further comprising a fourth thermal actuator that is formed in said first semiconductor layer and is connected to said first movable layer by a fourth tether.

20. The wavelength monitor of claim 19 wherein said first movable layer is rectangular and said first, second, third and fourth tethers are connected to approximate midpoints of sides of first, second, third and fourth said first movable layer.

21. The wavelength monitor of claim 16 wherein said first movable layer is released from a substrate.

22. The wavelength monitor of claim 16 wherein said first, second, and third thermal actuators are partially released from said substrate.

23. The wavelength monitor of claim 16 wherein said second stationary layer is flat.

24. The wavelength monitor of claim 16 wherein said second stationary layer is curved.

25. A method of tuning wavelengths using a microelectromechanical wavelength monitor, comprising the steps of:
providing a first wafer with a first semiconductor layer;
forming a first movable layer in said first semiconductor layer;
forming a first thermal actuator in said first semiconductor layer;
forming a second thermal actuator in said first semiconductor layer;
forming a third thermal actuator in said first semiconductor layer;
forming first, second and third tethers in said first semiconductor layer that connect said first, second and third thermal actuators to said first movable layer;
providing a second wafer with a trench defining a second stationary layer;
attaching said first and second wafers together; and
displacing said first movable layer relative to said second stationary layer by adjusting power applied to said first, second and third thermal actuators.

26. The method of claim 25 further comprising the step of:
forming a fourth thermal actuator in said first semiconductor layer; and
connecting said fourth thermal actuator to said first movable layer using a fourth tether.

27. The method of claim 24 further comprising the step of:
coating one side of said second stationary layer and said first movable layer with an highly reflective coating.

28. The method of claim 24 further comprising the step of:
coating another side of said first movable layer and said second stationary layer with a highly reflective coating.

29. The method of claim 24 wherein said first movable layer is circular and said first, second and third tethers are spaced approximately 120° apart.

30. The method of claim 25 wherein said first movable layer is rectangular and said first, second, third and fourth tethers are connected to midpoints of first, second, third and fourth sides of said first movable layer.

31. The method of claim 24 wherein said first movable layer is released from a substrate.

32. The method of claim 30 wherein said first, second, and third thermal actuators are at least partially released from said substrate.
